(19) United States
(12) Patent Application Publication
(10) Pub. No.: US 2009/0150178 A1
(43) Pub. Date: Jun. 11, 2009

(54) Method And System For Tracking Physical Metrics In A Social Commerce System

(76) Inventors: Rick Douglas Sutton, Redwood City, CA (US); Joseph Whitney Fabris, Los Gatos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/329,320

(22) Filed: Dec. 5, 2008

Related U.S. Application Data
(60) Provisional application No. 60/992,552, filed on Dec. 5, 2007.

(51) Int. Cl. G06Q 50/00; G06Q 90/00; G06Q 30/00; G01B 21/16; G01C 22/00; G01P 15/00; G01P 11/00; G04F 10/00; G01C 21/00

(52) U.S. Cl. 705/2; 705/1; 701/300; 705/14; 702/178; 702/158; 702/142; 702/160; 702/141

(57) ABSTRACT

A method and system for tracking physical metrics in a social commerce system is disclosed. According to one embodiment, the physical metric tracking system comprises a data registering unit that receives activity data by a user, a data processing unit that validates the activity data using a plurality of data validating algorithms and converts the validated data into a convertible value, and a storage that stores the activity data and the convertible value. The convertible value is traded with goods and services, or any other benefits in the social commerce system.

The present application claims the benefit of and priority to U.S. Provisional Patent Application No. 60/992,552 filed on Dec. 5, 2007, and is hereby incorporated by reference.

### FIELD

The field of the invention relates generally to a computer system and method for capturing users' activity and biometric data and specifically to a commerce system wherein convertible values rewarded for users' activity and healthy behavior are traded among various participants in the system.

### BACKGROUND

People exercise, either in a planned manner, or simply through the act of living a normal life. Their motivations vary from medical necessity to performance improvement, from leisure to an employment reason, from philosophical to environmental reasons, or for as many reasons as there are people. For one's health and for the impact that unhealthy lifestyles have on the healthcare systems, people tend to desire healthy lifestyles and wish to exercise more and regularly. Increasing worries of global warming also lead people and governments to encourage non-petroleum based methods of transportation. Walking, bicycling, skating, and other forms of exercises, as an alternative method of transportation, are encouraged by social programs such as carbon offsets, and ultimately have monetary value to the people and organizations in our society.

Society does offer a traditional conversion of work efforts (i.e., labor) to other incentives and convertible values. Prior art exercise effort conversion systems integrate charitable giving as an included system feature, in which members' exercise efforts are converted to social goods via charitable donations. These donations are supplied by corporate sponsors or by the members themselves, and the donation amount can be regulated by the normalization values established within the system.

Finding like-minded parties to network with and exchange exercise activity for goods or services has been considered as an Internet business model in the area of social goods (e.g., “green stamp” redemption) and health and wellness benefits.

### SUMMARY

A method and system for tracking physical metrics in a social commerce system is disclosed. According to one embodiment, the physical metric tracking system comprises a data registering unit that receives activity data by a user, a data processing unit that validates the activity data using a plurality of data validating algorithms and converts the validated data into a convertible value, and a storage that stores the activity data and the convertible value. The convertible value is traded with goods and services, or any other benefits in the social commerce system.

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1A illustrates an exemplary system architecture for tracking physical metrics of a user, according to one embodiment;

FIG. 1B illustrates exemplary modes of data transfer, according to one embodiment;

FIG. 2 illustrates exemplary data types stored in a database, according to one embodiment;

FIG. 3 illustrates a block diagram for exemplary data transfer methods, according to one embodiment;

FIG. 4 illustrates an exemplary message provided to a user after completing a data entry, according to one embodiment;

FIG. 5 illustrates a trace map of a user activity, according to one embodiment;

FIG. 6 illustrates an exemplary leader board, according to one embodiment;

FIG. 7 illustrates an exemplary sliding valuation scale, according to one embodiment;

FIG. 8 illustrates an exemplary feedback process for refining normalization tables, according to one embodiment;

FIG. 9 illustrates an exemplary data entry form for entering activity data, according to one embodiment;

FIG. 10 illustrates an exemplary data entry form for generating group commitments and tracking; and

FIG. 11 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for tracking physical metrics in a social commerce system is disclosed. According to one embodiment, the physical metric tracking system comprises a data registering unit that receives activity data by a user, a data processing unit that validates the activity data using a plurality of data validating algorithms and converts the validated data into a convertible value, and a storage that stores the activity data and the convertible value. The convertible value is traded with goods and services, or any other benefits in the social commerce system.

Our methods use a variety of data capture methods, from simple logging techniques needing very little infrastructure, to employing technology such as GPS, accelerometers, pedometers, phones, etc. Taking advantage of the ease, wireless capabilities, internet access, and computing power of present and upcoming devices, the present system and method offers stronger validation and seamless integration of the collection of the data into our database and further, into a member's lifestyle.

In the following description, for the purposes of explanation, specific nomenclature is set forth to facilitate an understanding of the various inventive concepts disclosed herein. However, it will be apparent to one skilled in the art that these specific details are not required in order to practice the various inventive concepts disclosed herein.

The present system and method also relates to apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of device including flash memory devices, floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, a system and method for collecting exercise, motion activity information, and/or biometric information and transferring the collected information to a database is described. The collected activity data may be further analyzed, normalized, and manipulated in a variety of ways to provide exchange rates and a resulting currency. This currency may be traded in a market provided by the present system and method and in other conventional online and offline markets as well.

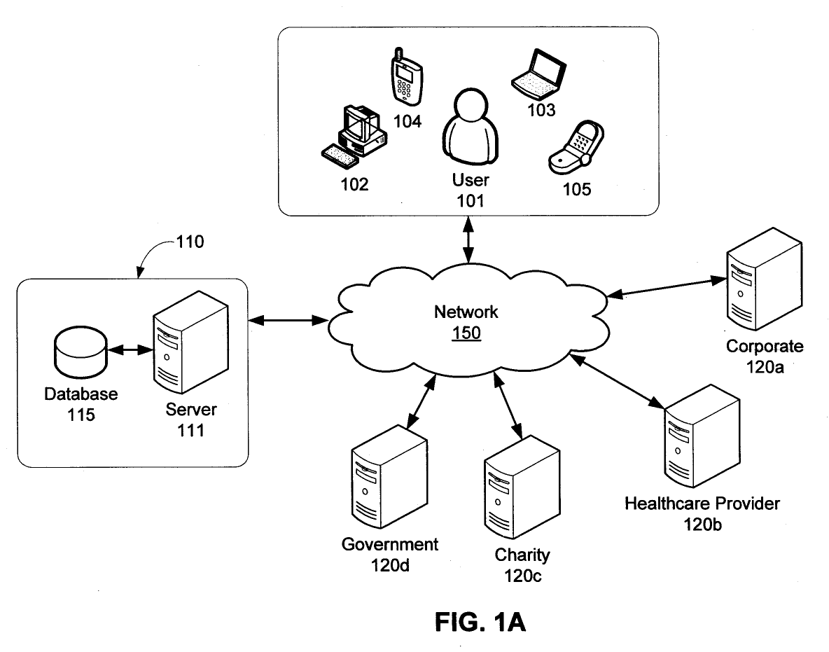

FIG. 1A illustrates an exemplary system for tracking physical metrics of a user, according to one embodiment. User 101 represents an individual or a group of individuals using the present system and method. User 101 may be registered to use the present activity and biometric tracking system 110. User 101 communicates with activity and biometric tracking system 110 via network 150 in a variety of ways including a computer 102, a laptop computer 103, a portable device 104, a smart phone 105, user' exercise equipment, or any other device that has connectivity with activity and biometric tracking system 110. Activity and biometric tracking system 110 has a server 111 and a database 115. Server 111 herein represents a collection of servers, for example, a Web server, a file server, a data aggregation server, a data processing server, etc. User 101's personal profile, exercise data, analysis data, and other user related data as well as user 101's activity data are stored in database 115. Other participants, collectively referred to as partners, include corporate sponsor user 101's sponsor or employer 120a, a health care provider 120b, a charitable organization 120c, and a government organization 120d. Partners 120 also communicate with server 111 to exchange their services, goods, and other offerings with user 101's currency values obtained from user 101's activities. The method of rewarding user 101's activities with redeemable currency values is described hereinafter in greater detail.

According to one embodiment, the present system and method creates a relationship between partners 120 and user 101's causes. User 101's cause may be a charitable cause (e.g., Safe Routes to Schools program) toward which user 101 earns points and matching donations from partner 120. Partners 120 may provide funds for charitable donations towards user 101's cause. Partners 120 may also provide goods and services that user 101 can purchase with a currency value rewarded for activities.

FIG. 1B illustrates exemplary modes of data transfer, according to one embodiment. User 101 may use a PC 102 or a laptop computer 103 to enter activity data by hand. User 101 may communicate with activity and biometric tracking system 110 via network 150 using a Web browser or an application program that system 110 provides. Alternatively, user 101 may be equipped with a device 104 that captures user 101's activity and biometric data, and the device 104 communicates with system 110 via network 150. User's device 104 may have a display 151 providing various information (e.g., current speed, average speed, distance, altitude, climb, calories) to user 101 while user 101 is performing an activity. The captured user's activity data is transferred to system 110 by a wireless connection if device 104 is wirelessly connected to system 110 or via network 150 when a proper connection is established between user's device 104 and system 110.

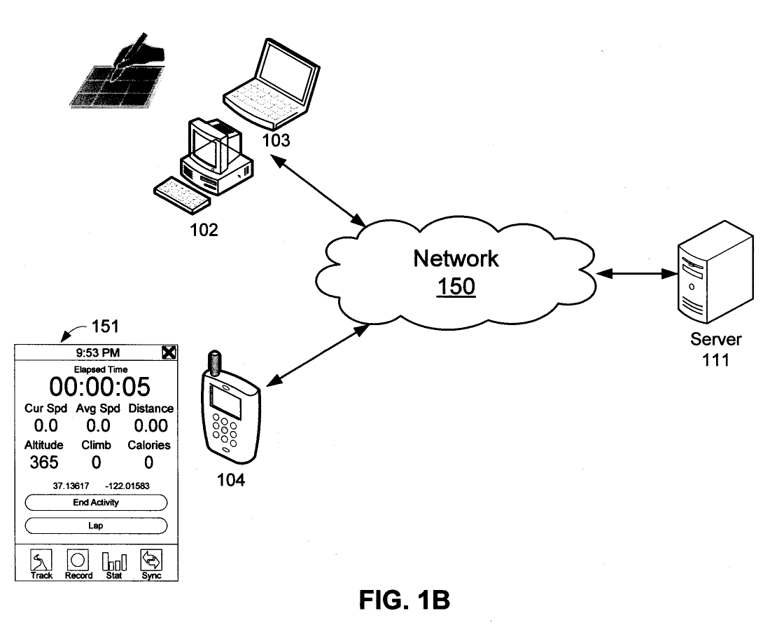

FIG. 2 illustrates exemplary data types stored in a database, according to one embodiment. Member profile data 201 contains user 101's personal information such as name, age, address, sex, or any other personal records. Member profile data 201 also contains data for causes, sponsors, and other members with whom user 101 interact within system 110.

Activity validation data 202 contains reference data, rules, method, and procedures used by data validation algorithms. Various validation algorithms are applied to user-provided data to find anomalies and metrics that fall out of the standard parameters such that mistakes and potential fraudulent data entry are prevented. For example, a maximum number of hours that a user 101 can enter per day is limited to 8 hours, and any entry for more than 8 hours might be red-flagged for invalid entry.

Carbon offset tables 203 contain parameters used to calculate benefits towards carbon offsets obtained as a result of user 101's activity and exercises (e.g., commute by bicycle). For example, riding a bicycle to work is considered a substitute for driving a gasoline powered vehicle to work. Such carbon offset activities are used for both personal satisfaction as well as in commercial, local, state, and federal government programs. Carbon offset data may be used as a measure to motivate user 101 to commute by bicycle. Carbon offset tables 203 also store rules, methods, and procedures to calculate carbon offset data as well as various carbon offset programs and laws.

Exercise data 204 contains user 101's exercise and biometric data during activities such as date of an activity, activity type, distance, duration, etc. User's exercise data 204 may be converted to other units and/or dollar amounts and stored in an exercise data table. Exercise data 204 for multiple users or a group may be collectively stored to track trends and progress towards a goal as a group.

Sponsor data 205 contains parameters provided by partners 120. User 101 may redeem a currency value for goods and services that partner 120 offers. Sponsor parameters, rules, and methods allows system 110 to balance the load of users 101 across multiple sponsors and causes. Sponsor parameter may include the maximum number of users 101 per sponsor and the maximum reward amount per users 101.

Exercise normalization tables 206 are used to convert different exercise types into a convertible asset for user 101's own benefits as well as charitable cause benefits. The converted assets are traded and exchanged and provide a platform for a commerce system. Cause data 207 relates user 101's activities with a charitable cause for which user 101 acts. Cause data 207 includes but is not limited to parameters for receiving finds, and methods for collecting donations.

Payment tables 208 contain user 101's accumulated currency value rewarded for his/her activities towards his/her choice of charitable cause. Payment tables 208 may also contain user 101's payment and usage history. It is appreciated that other validation and calculations related to a user's activity or exercise may be applied for promoting special interests and causes. Payment rules include basic payment schedule, kickers, incentives, accelerators to promote a certain activity during a certain period, or sponsor/cause parameters to monitor different payments from different combinations of sponsors and causes.

Healthcare/Government/Other tables 209 store users' biometric data such as heart rate (resting and active), blood pressure, height, weight, caloric expenditure, etc. These biometric data are used to track trends and progress for personal, motivational, and reward oriented reasons.

User 101's exercise activity may be a cycling activity. The cycling activity is assigned a currency value corresponding to the distance. The currency value may be redeemed for goods or services, or discounts on goods and services that partners 120 offer. The currency value may be used as a personal accomplishment or a competitive benchmark to be used as a part of a doctor's prescribed health directive, or applied to a corporate wellness program. Other examples of activities or sports that may benefit from the present system and method include but are not limited to: running, rowing, bicycling, soccer, weight lifting, skating, skiing, kayaking, paddling, climbing, dancing, walking, yoga, boxing, martial arts, general indoor exercises, wheelchair activities.

According to one embodiment, the present system and method may be used to promote participation of members and organizations in commercial and governmental programs by rewarding the participating member or organization in exchange for the proof of aforementioned activities. For example, a healthcare program may give discounts for a member's healthcare coverage or for medication at the proof of exercise activities by the member because of the reduced probability of healthcare costs claimed by the member. The present system and method provides a way to track and collect the records of a large number of users and their activities. The present system and method also provides a way to communicate with user 101's devices and present the collected data to interested parties (e.g., partners 120).

Throughout the following description, the terms, Site, Web site, and Web, are used to refer to user accessible network sites that implement the World Wide Web (WWW) standards for coding and transmission of hyper textual document. These standards include Hyper Text Mark Language (HTML) and Hyper Text Transfer Protocol (HTTP). It should be appreciated that the terms Web, site, and Web site are not intended to imply a single geographic location, as a Web of other network sites may include multiple geographical distributed computer systems that are linked together.

According to one embodiment, the present system and method provides a simple and effective way to track and collect the records of user 101's exercise and physical activities, consolidate them, and reward user 101 with currency values for his/her activities that can be used in a variety of ways. The rewarded currency values may be used, for example, to fund charitable causes and to earn points towards merchandise and services that partners 120 offer, and to use the earned points as validation to a variety of programs in which user 101 participates.

According to one embodiment, the present method and system provides activity “bank accounts” (or accounts in short) for user 101. An activity bank account contains various data fields such as route, heart rate, watts, calories, distance, time, timestamp, location. Comparable values and metrics, and a data validation field may be associated with each data field and used as a proof for an activity or as a currency value.

According to one embodiment, the present method and system provides a commerce system that allows conversion of the value in a user 101's bank account to a credit or as currency to purchase goods and services offered by partners 120.

According to one embodiment, the present method and system provides programs for corporate clients to enhance their “bank account” by providing additional benefits and incentives.

According to one embodiment, the present system and method provides a market wherein the currency values of users 101′ activities are used and redeemed. Alternatively, the present system and method may serve as a social networking platform supporting a set of complimentary services where users 101 mingle with other users by forming groups of similar interests or charitable causes, share information with each other, and commit to participate in activities with one another.

According to one embodiment, the present method and system serves as a social brokerage by linking corporate sponsors with members who have charitable causes.

According to one embodiment, the present method and system provides programs hosted by healthcare providers to encourage and reward their members for health enhancing activities.

According to one embodiment, the present system and method calculates carbon offset as a result of exercise efforts. The rising efforts to combat global warming spawned numerous programs and legislation to promote non-petroleum based transportation. Many local and federal governments allow individuals and corporations to receive subsidies, tax credits, and other monetary incentives to travel without using petroleum. The present system and method serves as a validation point to track, record, and validate these carbon offset activities to allow for users to receive rewards for their participation in these incentive programs. The carbon offset calculated for exercise efforts may be used to motivate participating users and organizations.

According to one embodiment, the present method and system provides a playground for users 101 who have active lifestyles and encourages them to stay active and healthy. For example, the present method and system develops group affiliations, provides tools to shop at member sites and affiliates and to target their efforts to benefit a charitable cause.

Users 101 may include people who are living an active life, people who are seeking an active healthy lifestyle, and people who wish to join other people who have similar interests. Target customers may also be individuals who are encouraging their friends and associates to reach their goals. Partners 120 may include health care providers, retail outlets, manufacturers, commercial organizations, charitable cause organizations, and governmental agencies.

According to one embodiment, user 101's activity data is collected in a variety of ways. User 101's activity data may be captured from an existing commercial or private mechanism. For example, a user may enter his/her activity data manually or import data from a data recording device including 102-105. The captured data are transferred to database 115 for validation and further data processing by server 111.

According to one embodiment, user 101's activity data is captured by an honor system where no user 101's device is used to capture data, and user 101 logs his/her own activity. According to another embodiment, a user's data is captured by a data validation system that utilizes data capturing/recording capabilities of a user 101's device such as a GPS, an accelerometer, or a heart rate monitor. The present activity and biometric tracking system 110 may provide interfaces to various types of data capturing/recording devices to collect a user's activities in a flexible and efficient manner.

The honor system relies on the estimation capabilities, the memory, and the honesty of a user to track and record his/her own activities. The honor system takes advantages of ease of use, no need for batteries or recording devices, and convenience. The demerits of the honor system include reduced accuracy, hand labor, human memory lapses, and potential fraud.

The data validation system uses a data capturing device that tracks, records, and provides a mechanism to export the captured activity data to activity and biometric tracking system 110. The data capturing device records the user's activities (e.g., traced map, running path, start/stop time) and/or biometrics (e.g., heart rate) in its on-board memory and later transfers the stored data to activity and biometric tracking system 110 over network 150. Examples of presently available data capturing devices are Polar® Heart Rate Monitors offered by Polar Electro OY, Garmin Edge® and Forerunner® series Personal Navigation Devices offered by Garmin Ltd., Apple iPhone® 3G offered by Apple Inc., Palm Treo Pro® offered by Palm, Inc., and Nokia N95® mobile phones offered by Nokia Corporation.

Data capturing devices capture and record a user's activity into their on-board memory and forward the captured user's activity data to activity and biometric tracking system 110 over network 150 either through a PC-based connection or from on-board wireless technology. The data capture device may be directly connected to activity and biometric tracking system 110 using wireless technologies such as WiFi, WiMax, and WAN (cell phone) networks. According to one embodiment, the captured user's activity data may be temporarily stored on the user's PC and forwarded to activity and biometric tracking system 110 at a later time. Data capturing devices may operate with software that provides network connection and data forwarding functionalities.

According to one embodiment, a pedometer or an accelerometer may be used alone or in combination with other data capturing devices to capture a user's activity data. For example, the number of steps taken by a user is measured by a pedometer and used to calculate distance traveled and calories burned.

User's activity data captured by a data capturing device may include but is not limited to: start time, finish time, distance traveled, average speed, max speed, accumulated elevation gain and loss. User's data capturing device may have a built-in timer to capture the user's activities along with timestamps. The data capturing device may also capture coordinate data for the course traveled during the activity. The data capturing device may capture the user's biometric data such as heart rate, which later may be used to monitor for performance improvement or to provide feedback to the user. For example, if a user's heart rate data is out of a range that is considered to be safe, a warning message may be sent to the user either during the activity or at the time of data transfer to activity and biometric tracking system 110.

According to one embodiment, user 101 transfers data from his/her data capturing device to a PC via a USB/cable connected thereto. The present system and method takes advantage of an infrastructure and hardware that enable the wireless transfer of a user's activity data wirelessly. Wireless data transfer allows for faster data exchange and real-time reporting and display.

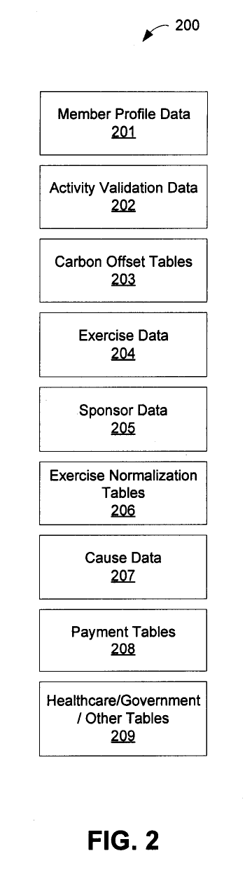

FIG. 3 illustrates a block diagram for exemplary data transfer methods, according to one embodiment. Data transfer methods are categorized into three main themes: manual transfer, manual device transfer, and automatic device transfer. First, user 101's activity data is entered (301). The user-provided data is checked to determine whether or not it is received from a user 101's device (302). If the user-provided data is manually entered by user 101, the data is checked to determine whether it includes a traced map (303). If the user-provided data that has a traced map, user 101 enters metrics on a traced map (308, 309) to complete the map data along with the associated metrics. If the user-provided data is generated from a user 101's device, the user 101's device is checked to determine if it has a direct connection to server 111 (310). If the user 101's device has a direct connection to server 111, user 101's data is automatically transferred (312), otherwise uploaded either by user 101 or an application program (not shown) that transfers the data to server 111 (311).

User 101 is prompted to have an opportunity to correct and edit the entered activity data (304). User 101 enters sport category and other required or optional fields to complete the data entry. The user-provided data is stored in database 115 (305), and server 111 applies various data conversion and processing algorithms as well as applies other system metrics (306). Optionally, server 111 communicates with user 101 to ask for the confirmation of data upload and transfer and notifies user 101 of the amount rewarded for the activity associated with the user-provided data (307).

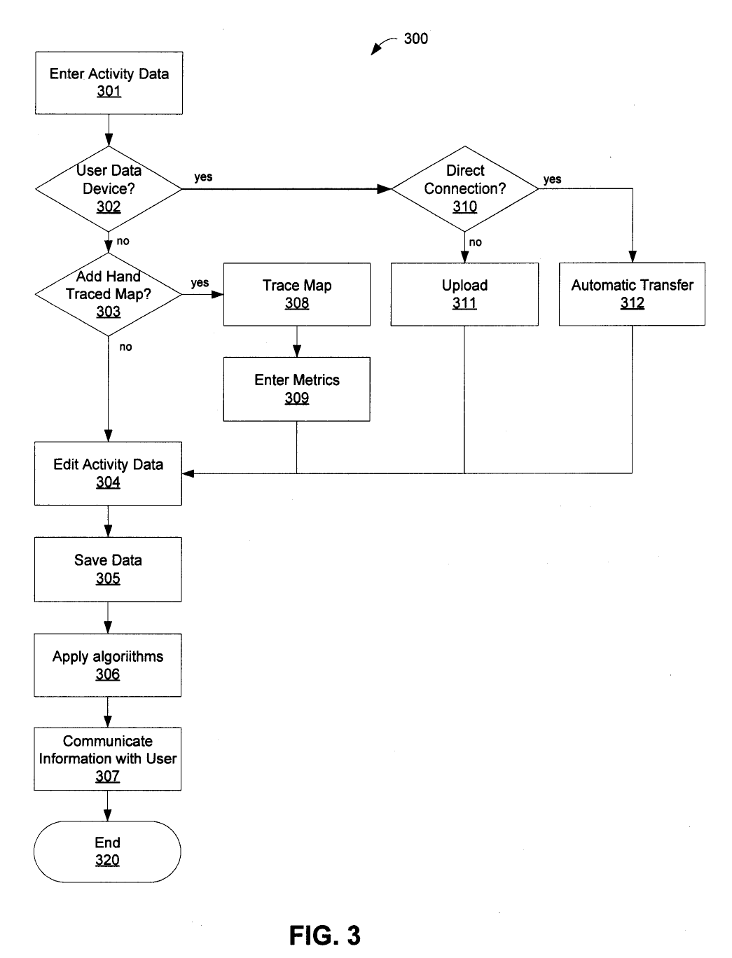

FIG. 4 illustrates an exemplary message provided to a user after completing a data entry, according to one embodiment. User 101 confirms the redeemable amount in exchange for his/her activity. This notification message 500 may be provided to user 101 by a Web interface of server 111 or any other form of communication (e.g., email, SMS message) chosen by user 101.

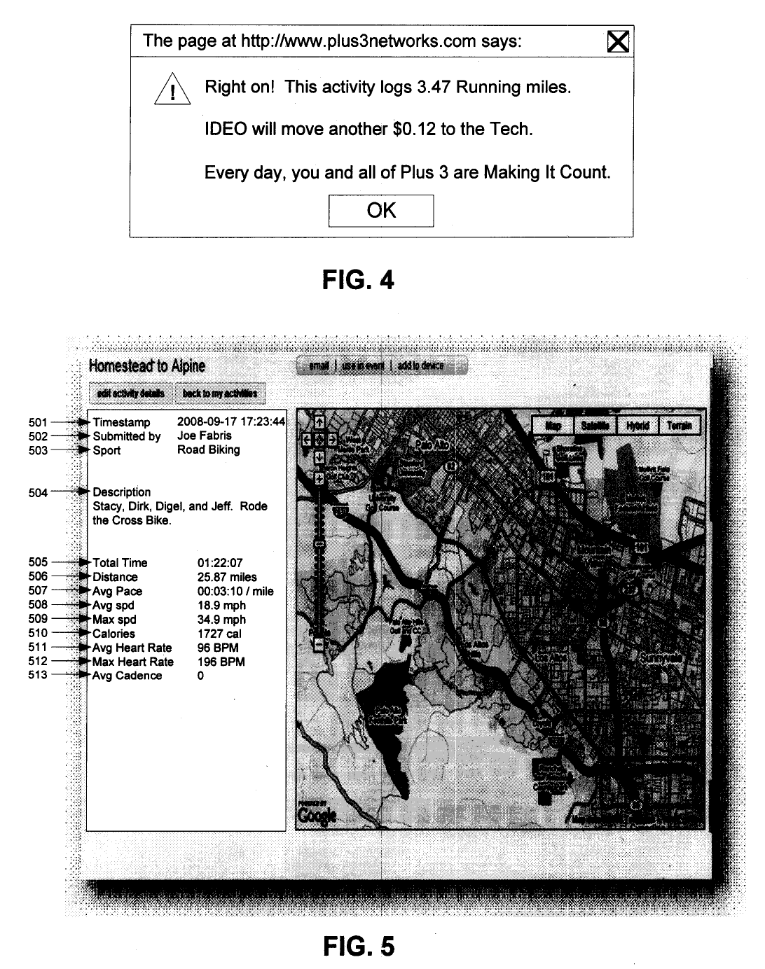

FIG. 5 illustrates a trace map of a user activity, according to one embodiment. User 101 may edit the traced map when entering the data or at a later opportunity if a correction for the previously entered data is required. User 101 may enter the associated data with an activity displayed on a map including but not limited to time stamp 501, user name 502, type of sport 503, description of the activity 504, total time 505, distance 506, average pace 507, average speed 508, maximum speed 509. Other information such as calories 510, average heart rate 511, maximum heart rate 512, and average cadence 513 may be entered by user 101 or calculated by activity and biometric tracking system 110 based on the user-provided data.

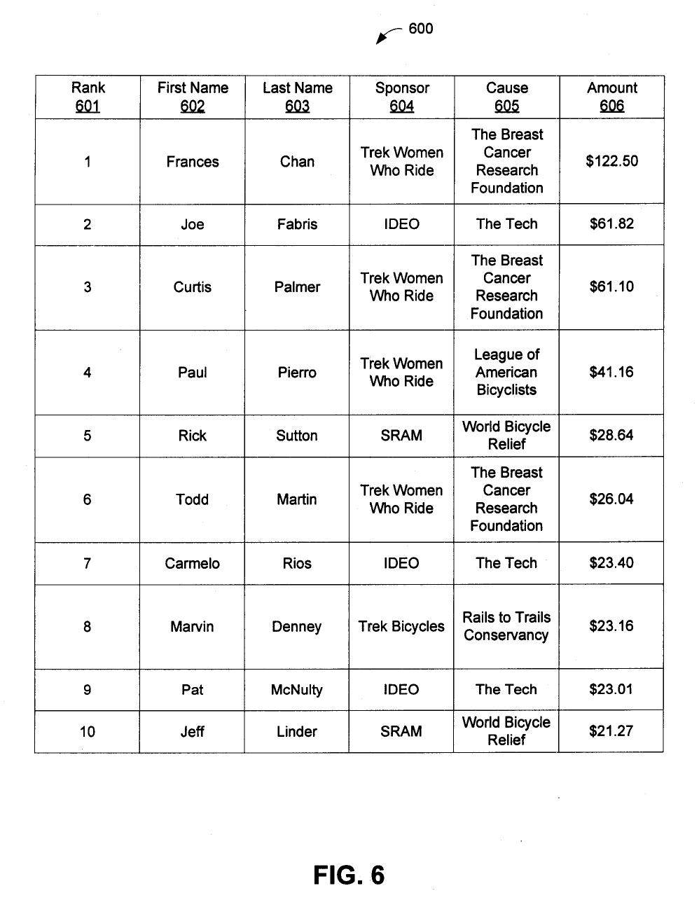

FIG. 6 illustrates an exemplary leader board, according to one embodiment. Leader board 600 contains columns of rank 601, first and last name 602 and 603, sponsor 604, cause 605, and amount 606. The leader board 600 may be sorted by a group to which user 101 belongs to monitor the group's activity and his/her rank within the group. Similarly, the leader board 600 may be sorted by a cause 605 to monitor the activities performed for the cause 605. The accrued amount by a user identified first and last name 602 and 603 may be redeemed for the charity identified by the cause 605 or goods and services that sponsor 604 offers.

According to one embodiment, the present system and method provides a sliding scale of values to discern the level of difficulty of activities and the level of data validity. For example, a lower value is given to manually entered honor system data than data entered with a more reliable data entry method because of its higher level of validity. For example, a pedometer may generate more reliable data including the exercise time, the number of steps, and the distance. The pedometer-generated data is considered to have higher level of data validity than user-entered data, and is given a higher value than the user-entered data. Data generated by a more sophisticated device that tracks the actual route taken (i.e., a GPS) may be assigned even higher value. Such data may not be easily manipulated or tampered by human intervention, and is thus given a higher level of trust and validity.

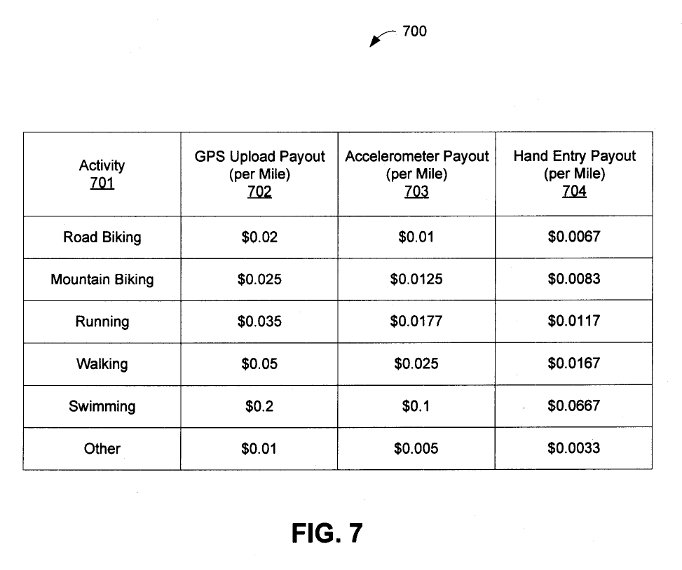

FIG. 7 illustrates an exemplary sliding valuation scale, according to one embodiment. Table 700 shows examples of activities 701 and different reward rates 702-704 depending on the tracking method. For example, GPS-provided data 702 for road biking is given $0.02 per mile. Hand entry data 704 for the same exercise is given only $0.0067 per mile. Accelerometer-generated data 703 for the same exercise is given a value of $0.01 per mile that is between the amount for the GPS-provided data and the hand entry data. Walking the same distance is considered to be more labor intensive, thus is rewarded a higher value than road biking or mountain biking. The numbers and activities shown in table 700 are examples only, and it is appreciated that other numbers and activities may be used without deviating from the scope of the present subject matter.

According to one embodiment, the honor system provides user 101 flexibility of data entry yet the least amount of investment to record and upload activity data. User 101 may manually fill in the fields of a browser with, for example, “Run, five miles, forty minutes.” Such user-entered activities are given, for example, $0.0117/mile. On the other hand, GPS validated activity information contains detailed information such as the actual route, the actual miles/minute, an accurate distance, thus preventing user 101 from cheating an entry into the system. Due to the higher level of validity and trust, GPS validated activity data are given a higher amount per mile, for example, $0.035/mile.

In one embodiment, user 101's activities are monitored using a user 101's device. For indoor exercises to be qualified for an activity, user 101's heart rate (or calculated calories burned during the exercise) is monitored over a time period, and checked if the heart rate stayed over a threshold. In a similar fashion, GPS data or other activity data may be used to validate whether user 101 did perform the exercise. The earned points as a result of the exercise are rewarded to user 101's account.

According to one embodiment, both the user-entered or device-generated activity data are checked for their legitimacy and errors. For example, the GPS-generated activity data for “Run, five miles, forty minutes” are analyzed by a data validation algorithm. If it is found that the five mile run was actually done over a freeway, at 50 mph, in five minutes, the activity data obviously exceeds the capability of a human. The activity data is flagged and not allowed to be counted as a valid activity.

According to one embodiment, activity data are validated using various validation algorithms. Activity data are validated, adjusted and flagged for intentional or unintentional errors by validation filters. Examples of such activity data are timestamp data validated over their currency and accuracy; person data validated over data transparency and accountability (i.e., data is seeable by others to build confidence in the system); total time, distance, and average speed data validated to be within a person's skill and ability as well as within the user's personal skill and ability; biometrics of the user (e.g., heart rate) validated to match the user's physiological ability; and route data validated over the associated activity data and traceable streets and terrains.

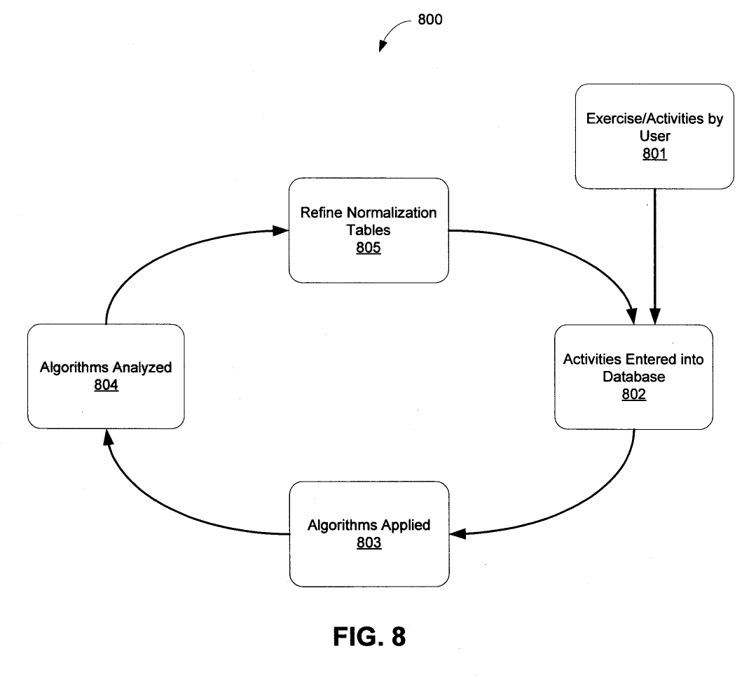

FIG. 8 illustrates an exemplary feedback process for refining normalization tables, according to one embodiment. Normalization tables are used to convert different types of exercises and activities into a normalized setting such that varying currency values are rewarded for the user's exercises and activities. User 101's exercise or activity data is entered manually by user 101 or user 101's devices 102-105 (801) using the aforementioned data transfer methods. Server 111 receives the user-entered data and stores it in database 115 (802). Various algorithms are applied to validate the user-entered data against activity validation data 202 and to convert the user-entered data into activity data using carbon offset tables 203, normalization tables 206, and payment tables 208 (803). The algorithms also analyze the validated and processed data for consistency, fairness and other factors (804). Users' feedback may also be applied during the analysis at 804. Using the analysis data obtained at 804, normalization tables 208 are refined, and the refined normalization tables 208 are applied to the next sets of user-entered data (805). This feedback process is repeated to further refine data consistency and fairness.

Normalization table 206 is based on real world activities that reflect the actual activity type, frequency, duration, and effort that a regular user (as opposed to dedicated highly trained athletes) can put toward his/her day. The present system and method motivates and rewards users with payouts and values that keep a very wide range of activities relevant and important to their lifestyles.

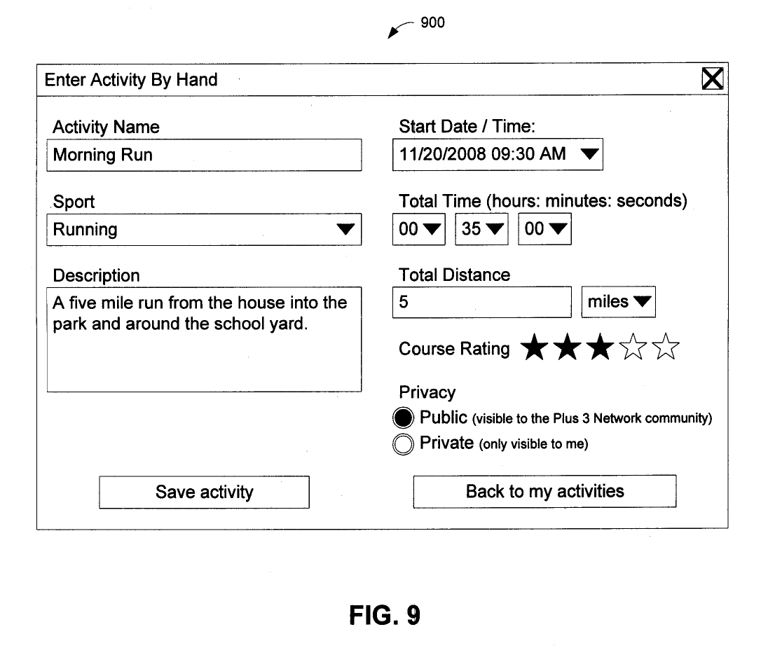

Manual transfer method uses an input mechanism of a PC or a cell phone keypad to enter data. FIG. 9 illustrates an exemplary data entry form for entering activity data, according to one embodiment. A user interface using a Web browser, a browser from a phone, text messages or emails may be used for data entry. User 101 may use a PC, a phone, or any other data entry device to enter his/her activity data. Various validation algorithms and rules are applied to the user-entered data for checking its legitimacy and error. For example, the time data can not exceed 24 hours, and the maximum heart rate must be below 220 beats/second. The maximum heart rate for a user may be specified by his/her age and other physical data specified by the user's profile.

Referring back to FIG. 3, for a manual device transfer method, user 101 logs data with a device at decision point 303. According to one embodiment, user 101 is presented a user interface for data transfer when using computer software for uploading the activity data. Using the data that the user 101's device has captured, user 101 enters data from the user interface. After the data is transferred, various algorithms and rules are applied to check the legitimacy and errors of the user-entered data, and the verified user's data are entered into the user's account.

For automatic device transfer method, user 101 does not need to manually enter data. For example, the user's device automatically or semi-automatically links to the Internet to log data. The user's device may also provide real-time data transfer to the database while the user 101's activity is taking place.

According to one embodiment, the present system and method provides a validation mechanism to build “trust” among the issuer and the recipient of the currency. The validation mechanism may employ digital technology such as GPS and other motion/activity recording devices to prevent fabricated data entry. For preserving data integrity, user's device may encrypt captured data using an encryption key and transfer encrypted data such that user 101 may not be able to tamper the captured data.

According to one embodiment, the present system and method detects input mistakes, fraud, and accidental entries to help a currency issuing partner 120 to have confidence and trust for the activity data to be converted for the currency. In one embodiment, a market is built around the validated data. User 101 uploads data into his/her account, and the uploaded data are stored and converted to “points” or “currency.” The “points” and “currency” may be shared amongst interested parties and traded or exchanged for goods and services. According to one embodiment, user 101's activity data are converted to a currency and exchanged in a market that accepts the currency. Currency used herein refers to any exchange medium, imaginary or tangible, that has a face value and exchanged in a market for goods or services. The market may be a conventional online market over the Internet or an offline store that honors the currency.

According to one embodiment, earned points may be converted to charitable donations (points to cash) by relating corporate sponsors and charitable organizations. According to another embodiment, earned points are converted into member rewards program for goods and services. Earned points may be exchanged for gifts or discounts with affiliated manufacturers and retailers.

According to yet another embodiment, earned points may be used for healthcare or medical purposes. Health care providers and HR departments of a corporation may validate exercise efforts of their members or employees using the present system and method and reward them with points or other incentives such as 401K matching, added vacation days, etc. For this purpose, a software application and a data capturing device may be provided to each of the members and employees to track, record, and manage their exercise efforts.

Based on data models in different fields of endeavor, the present data capturing method provides a model that takes into account how a normal person behaves during a day. With a combination of hand-entered and validated activity data, appropriate weighting and other modeling methods are applied to make sure rewarding payouts are relevant and motivational.

According to one embodiment, the present system and method provides applying new metrics to existing types of activities. For instance, instead of using mileage rewards for a bike ride, vertical climbing or average miles per hour may be used as a metric. Alternatively, unique combinations of multiple metrics with mathematical formulas may be used to provide payout metrics. For the data that are captured automatically and accurately, human errors that are introduced by manual input or device errors may be removed using the aforementioned validation filters.

According to one embodiment, the present system and method provides a mechanism for data display and review. In one embodiment, user 101 or user 101's device provides coordinate data for his/her activities using application software that gathers real world geographic locations on a map. Using accurate geographic data that user 101's device generates, a library of user 101's exercise activities is created including a geographical map that displays the exact route that user 101 ran, biked, swam, etc. Each time user 101 exercises, the updated route information expands user 101's library of workout data. With the help of computer technology, user 101's uploaded route may be viewed in 2D or 3D on a map along with other activity data (e.g., heart rate, distance traveled).

According to one embodiment, the present system and method shows a user's accomplishment in a recognizable manner to keep the user motivated to continue and come back for exercising efforts. A set of motivational tools may be used to show what a user has accomplished and his/her working progress towards a goal, such as earned points and values, achieved milestones, achieved group activities, and other motivational goals that the users set. In one embodiment, merit badges, recognition signs, leader boards, and other platform for human expression may be used to allow a user to create his/her personality and communicate with other users in the system.

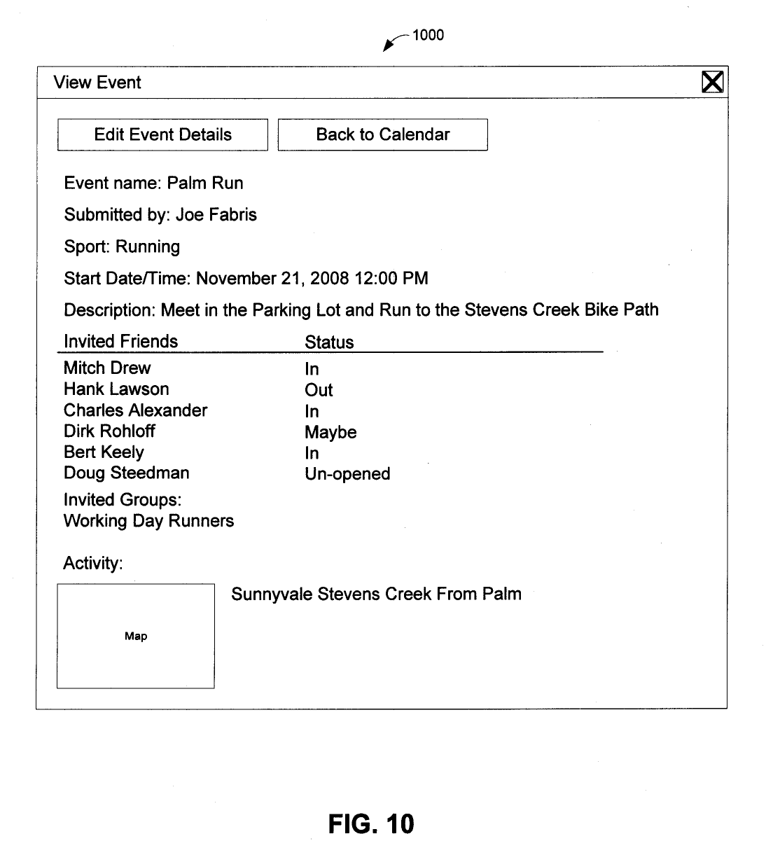

FIG. 10 illustrates an exemplary data entry form for generating group commitments and tracking, according to one embodiment. User 101 may create an event for other users to join. Each user may view the event in his/her calendar. A group event may be created by inviting a group of users, and each user can accept, decline or defer the decision to join the organized event. The group event may show a trace map 1005 to give an overview of the course that the group will be hiking, riding, running, etc.

Many Web-based tools only let people link in virtual ways. The present system and method provides tools for interactive connections with other users, sharing activities, comparing activities, posting virtual competitions and results, and other leader boards. The present system and method also provides tools to allow users to network in the real world. For example, social groups with similar exercise interests and geographical locations (e.g., cycling group, San Jose based group, weight lifting group, alumni group) may be formed to allow offline networking amongst the group members.

According to one embodiment, the present system and method allows for efficient creation and management of activities that connect individuals and groups of individuals. The present system and method provides a platform that locates people within a geographical area using a location-sensing device such as GPS so that people can be dynamically tracked and connected if they desire.

According to one embodiment, user 101's device may run application software and detect the location of buddies (e.g., users in a special interest group) who are within a geographic area. The buddies' activity data may be monitored or displayed real-time to the inquiring user to detect the buddies' activities. For example, on a mountain bike ride, a solo rider may find his/her buddies riding on the same trail. In another example, an injured buddy in an isolated area may be identified and accurately located. The biometric of the injured buddy might be remotely monitored to provide the best possible rescue efforts.

Using the GPS data generated by user 101's device, users 101 with similar pace and effort and users 101 within a common geographical area may be connected. The present system and method may also be used to arrange meeting times, places, directions, and reminders for a group activity.

According to one embodiment, the present system and method utilizes user profiles and collected users' activity data (e.g., speed, exercise term, location) to provide a unique opportunity to meet other users who have similar exercise regimens. Thereby, people who are seeking new venues or traveling to a new location may be easily connected. Using the services that the present system provides, users locate exercise opportunities and meet like-minded users in new venues. Users who are traveling a new area may find and network with other users in the area who shares same interests and activities.

According to one embodiment, the present system and method allows users to browse and monitor competitions from other users. User 101 creates a personal profile and uploads his/her GPS tracked exercise efforts. Application software compares and contrasts user 101's efforts for incentives, prizes, and general interests.

Simple challenges, such as logging a certain number of events or completing a certain amount of mileage over a given time, are easy ways to engage a membership and motivate users' activity and logging. With a large group of users with diverse demographic and interests and regional, personal, and other parameters associated with the users' profiles, advanced competition and reward programs may be utilized. For example, an attorney's point competition program may be staged to draw attorney members to complete for most points earned in a given timeframe regardless of their location, sport preference, time of day, etc. Other examples of competitions or contests include sport-specific events (e.g., cycling, running), vocation-specific events (e.g., attorneys, doctors, students), age group-specific events (e.g., 18-24 yrs, 40-49 yrs), location-specific events (e.g., cycle a defined course, upload your data, compare with others' data who have ridden the same course), events for most money raised for charity.

According to one embodiment, the present system and method provides data verification, reports, and other information for members, sponsors, and benefactors. In one embodiment, users' data are aggregated to show trends, conclusions, and demographic and psychographic information. In another embodiment, user's data is aggregated to show currency exchange to business partners for tracking, certification, and verification. Data may be presented or displayed to members, sponsors, and benefactors using a Web browser, a widget on a computer, a phone, or other internet-enabled device or an application program directly from users' device.

According to one embodiment, the present system and method presents various communication channels with partners when making markets, conducting commerce transactions, and providing validation to entities on member's activities. Depending on the level of sophistication, budget, and requirements of partners, differing methods may be employed to connect with the partners. For example, written paper reports, electronic reports attached in emails, manually transmitted digital data, automated data transfer, or Web services for automated real time transference may be used.

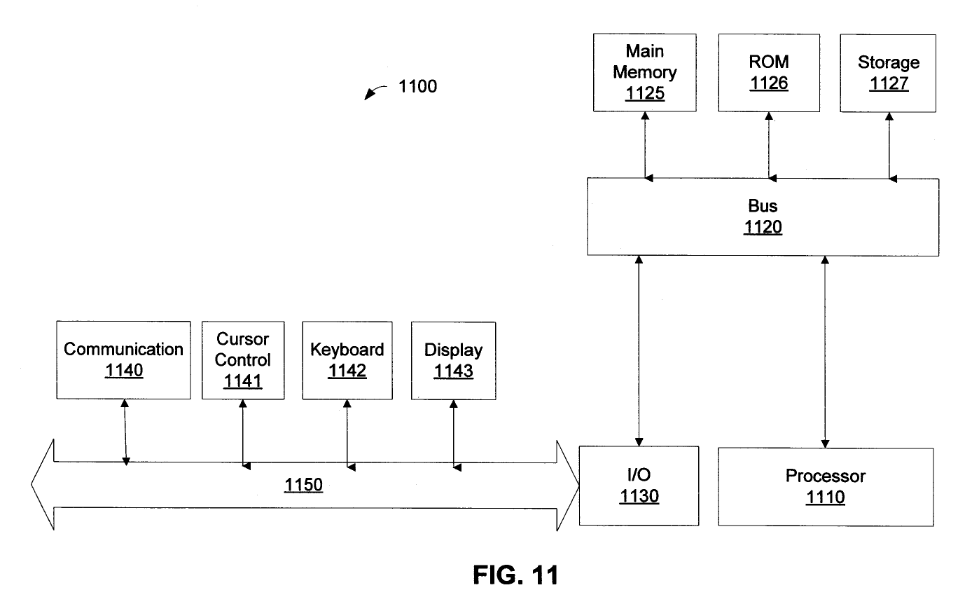

FIG. 11 illustrates an exemplary computer architecture 1100 for use with the present system, according to one embodiment. Computer architecture 1100 may be used to implement activity and biometric tracking system 110 with all or a part of the components shown in FIG. 1. One embodiment of architecture 1100 comprises a system bus 1120 for communicating information, and a processor 1110 coupled to bus 1120 for processing information. Architecture 1100 further comprises a random access memory (RAM) or other dynamic storage device 1125 (referred to herein as main memory), coupled to bus 1120 for storing information and instructions to be executed by processor 1110. Main memory 1125 also may be used for storing temporary variables or other intermediate information during execution of instructions by processor 1110. Architecture 1100 also may include a read only memory (ROM) and/or other static storage device 1126 coupled to bus 1120 for storing static information and instructions used by processor 1110.

A data storage device 1127 such as a flash memory, a magnetic disk or optical disc and its corresponding drive may also be coupled to computer system 1100 for storing information and instructions. Architecture 1100 can also be coupled to a second I/O bus 1150 via an I/O interface 1130. A plurality of I/O devices may be coupled to I/O bus 1150, including a display device 1143, an input device (e.g., an alphanumeric input device 1142 and/or a cursor control device 1141).

The communication device 1140 allows for access to other computers (servers or clients) via a network. The communication device 1140 may comprise a modem, a network interface card, a wireless network interface or other well known interface device, such as those used for coupling to Ethernet, token ring, or other types of networks.

A method and system for tracking physical metrics in a social commerce system have been described. It is understood that the embodiments described herein are for the purpose of elucidation and should not be considered limiting the subject matter of the present patent. Various modifications, uses, substitutions, combinations, improvements, methods of productions without departing from the scope or spirit of the present invention would be evident to a person skilled in the art.

We claim:

1. A system comprising:
a data registering unit that receives activity data from a user;
a data processing unit that validates the activity data using a plurality of data validating algorithms and converts the activity data into a convertible value; and
a storage that stores the activity data and the convertible value.

2. The system of claim 1, wherein the activity data is manually entered by the user.

3. The system of claim 1, wherein the activity data includes start time, finish time, distance traveled, average speed, max speed, accumulated elevation gain and loss.

4. The system of claim 1, wherein the activity data is generated by a user's device.

5. The system of claim 4, wherein the user's device tracks the user's activity and physical metrics.

6. The system of claim 5, wherein the user's device is a GPS, an accelerometer, a pedometer, or a heart rate monitor.

7. The system of claim 4, wherein the user device wirelessly transfers the activity data to the data registering unit.

8. The system of claim 1, wherein the user's activity includes running, rowing, bicycling, soccer, weight lifting, skating, skiing, kayaking, paddling, climbing, dancing, walking, yoga, boxing, martial arts, general indoor exercises, and wheelchair activities.

9. The system of claim 1, wherein the convertible value is assigned using a normalization table, the normalization table converting the activity data based on the type, duration, effort level of the user's activity, and trust level of the user's activity data.

10. The system of claim 1, wherein the data registering unit comprises a data entry tool to enter the activity data.

11. The system of claim 10, where the data entry tool is a Web user interface, a browser from phone, text messages or emails.

12. The system of claim 1, wherein the activity data is displayed on a traceable map.

13. The system of claim 1 further comprising a market wherein the user trades the convertible value for goods and services that a partner offers.

14. The system of claim 1, wherein the convertible value is assigned in other forms including 401K matching, vacation days, reduced healthcare cost for the user.

15. A method for tracking physical metrics of a user comprising:
receiving activity data generated from the user's activity;
validating the activity data using a plurality of data validating algorithms;
converting the activity data to a convertible value; and
storing the activity data and the convertible value in a database.

16. The method of claim 15, wherein the activity data is manually entered by the user.

17. The method of claim 15, wherein the activity data includes start time, finish time, distance traveled, average speed, max speed, accumulated elevation gain and loss.

18. The method of claim 15, wherein the activity data is generated by a user's device.

19. The method of claim 18, wherein the user's device tracks the user's activity and physical metrics.

20. The method of claim 19, wherein the user's device is a GPS, an accelerometer, a pedometer, or a heart rate monitor.

21. The method of claim 18, wherein the user device wirelessly transfers the activity data.

22. The method of claim 15, wherein the user's activity includes running, rowing, bicycling, soccer, weight lifting, skating, skiing, kayaking, paddling, climbing, dancing, walking, yoga, boxing, martial arts, general indoor exercises, and wheelchair activities.

23. The method of claim 15, wherein the convertible value is assigned using a normalization table, the normalization table converting the activity data based on the type, duration, effort level of the user's activity, and trust level of the user's activity data.

24. The method of claim 15 further comprising providing a data entry tool to enter the activity data.

25. The method of claim 24, where the data entry tool is a Web user interface, a browser from phone, text messages or emails.

26. The method of claim 15 further comprising displaying the activity data on a traceable map.

27. The method of claim 15 further comprising providing a market wherein the user trades the convertible value for goods and services that a partner offers.

28. The method of claim 15, wherein the convertible value is assigned in other forms including 401K matching, vacation days, reduced healthcare cost for the user.
